(19) United States
(12) Patent Application Publication
(10) Pub. No.: US 2007/0200484 A1
(43) Pub. Date: Aug. 30, 2007

(54) Display device

(75) Inventors: Tsutomu Kuniyasu, Mobara (JP); Go Saitou, Mobara (JP); Terunobu Satou, Mobara (JP); Hideyuki Shintani, Mobara (JP); Tomoki Nakamura, Chiba (JP); Katsuhide Aoto, Chiba (JP); Masakazu Sagawa, Inagi (JP); Yoshiro Mikami, Hitachiota (JP)

Correspondence Address: MILBANK, TWEED, HADLEY & MCCLOY, 1 CHASE MANHATTAN PLAZA, NEW YORK, NY, 10005-1413, US

(73) Assignee: Hitachi Displays, Ltd.

(21) Appl. No.: 11/710,801

(22) Filed: Feb. 26, 2007

(30) Foreign Application Priority Data
Feb. 28, 2006 (JP) 2006-052559

(51) Int. Cl. H01J 9/02; H01J 1/00; H01J 63/04; H01J 1/62

(52) U.S. Cl. 313/495; 313/497; 313/310; 313/311

(57) ABSTRACT

A flat panel display device is provided which prevents color mixture of the phosphor surface thereof to promote high brightness and longer operation life.

The flat panel display device is configured such that a front substrate 2 provided with the phosphor surface and a back substrate 1 provided with electron sources 10 arranged in a matrix manner are arranged to be opposed to each other via a support frame 3 and both the substrates 1, 2 and the support frame 3 are hermetically sealed. The electron source 10 has a triangular surface which faces the front substrate 2.

### CLAIM OF PRIORITY

The present application claims priority from Japanese Application JP 2006-052559 filed on Feb. 28, 2006, the content of which is hereby incorporated by reference into this application.

### BACKGROUND OF THE INVENTION

1. Field of the Invention

The present invention relates to a flat panel display device which utilizes an emission of electrons into a vacuum space defined between a front substrate and a-back substrate.

2. Description of the Related Art

Color cathode ray tubes have been widely used as display devices which exhibit high brightness and high definition. However, along with the recent request for higher quality images in information processing equipment or television broadcasting, the demand has been increased for planar displays (flat panel displays (FPD)) which are light in weight and requires a small space, while exhibiting high brightness and high definition characteristics.

As the typical examples of the flat panel displays, liquid crystal devices, plasma display devices and the like have been put into practice. More particularly, as display devices that can promote high brightness, a self-luminous type display device which utilizes an emission of electrons from an electron source to a vacuum is intended to be put into practice. Such a self-luminous type display device is called electron emission type or field emission type flat panel display devices for example. In addition, an organic EL display, which is characterized by lower power consumption, will be commercialized. In this way, various flat panel display devices have bee intended to be put into practice.

The self-luminous type flat panel display devices among such flat panel display devices have been known to have a configuration in which electron sources are arranged in a matrix manner. As one of them, the electron emission type flat panel display device described earlier has been known which uses minute integratable cold cathodes.

The self-luminous type flat panel display device uses a thin film type electron source or the like as the cold cathode. Examples of the thin film type electron source include Spintdt type, a surface conduction type, a carbon nonotube type, a MIM (Metal-Insulator-Metal) type which laminates metal-insulator-metal, a MIS (Metal-Insulator-Semiconductor) type which laminates metal-insulator-semiconductor, and a metal-insulator-semiconductor-metal type.

The electron emission type flat panel display has a display panel which is known to be configured to include the back substrate provided with the electron sources described above, a front substrate opposed to the back substrate, and a support frame as a sealing frame. The front substrate is provided with a phosphor layer and anodes adapted to generate an acceleration voltage for allowing electrons emitted from the electron sources to impinge on the phosphor layer. The sealing frame seals the inner space defined between both the substrates opposed to each other at a predetermined vacuum state. The electron emission type flat panel display is operated by combining such a display panel with a drive circuit.

The electron emission type flat panel display device is provided with a back surface which includes a large number of first lines (e.g., cathode lines or video signal lines), an insulating film formed to cover the first lines, a large number of second lines (e.g., gate lines or scanning signal lines) and a large number of electron sources. The first lines extend in a first direction and are arranged to be juxtaposed to each other in a second direction crossing the first direction. The second lines extend in the second direction on the insulating film and are arranged to be juxtaposed to each other in the first direction. The electron sources are disposed near the respective crossing portions between the first lines and the second lines. The back substrate has a board made of an insulator, on which the lines are formed.

With this configuration, scanning signals are sequentially applied to the scanning signal lines. Respective connection lines are formed on the board to connect the electron source to the scanning signal line and to the video signal line. Electrical current is supplied to the electron source. The back surface is opposed to the front substrate provided with phosphor layers for a plurality of colors and with anodes. The front substrate is formed of a light-transmitting material, preferably glass. A support frame serving as a sealing frame is interposed between both the substrates so as to seal therebetween. The inner space defined by the back substrate, the front substrate and the support frame is brought into a vacuum state.

The electron source is positioned near the crossing portion between the first line and the second line. An emission quantity (including ON and OFF of emission) of electrons from the electron source is controlled in response to the potential difference between the first electrode and the second electrode. The electrons emitted are accelerated by the high voltage applied to the anode located on the front substrate and impinge on the phosphor layer of the front substrate. The phosphor is excited by electrons to generate light with color according to the light emission characteristics of the phosphor layer. In general, the shape of the phosphor layer is rectangular and the special shape is rhombic, which is disclosed in Japanese Patent Laid-open No. 11-317183.

Each electron source and a phosphor layer corresponding thereto are paired with each other to constitute a unit pixel. Unit pixels of three colors, red (R), green (G) and blue (B), usually constitute one pixel (color pixel). Incidentally, for the color pixel, the unit pixel is called a sub-pixel. Japanese Patent Laid-open No. 2001-312958 discloses the arrangement of the electron sources in which, in the display device having vertical type electron sources, the electron sources are arranged in parallel to each other in a row direction and the electron sources adjacent to each other in a column direction are arranged to be shifted by half the electron source.

The flat panel display device as described above includes a plurality of interval maintaining members (hereinafter referred to as the spacer) which are fixedly disposed in a display area surrounded by the support frame between the back substrate and the front substrate. Thus, the interval maintaining members maintain the interval between both the substrates at a desired clearance in cooperation with the support frame. The spacer is made of a plate-like body formed of an insulator such as glass or ceramic. The spacer is usually installed every plurality of pixels at a position which does not interfere with the action of the pixels.

The support frame serving as a sealing frame is fixedly attached to the inner circumferential edge between the back substrate and the front substrate with a sealing member such as frit glass. This fixedly attached portion is hermetically sealed. The inside of the display area defined by both the substrates and the support frame has a degree of vacuum of e.g. 10⁻⁵ to 10⁻⁷ Torr.

First lines and second lines formed in the back substrate penetrate the sealing area between the support frame and the substrates. The first and second lines are formed at their leading ends with a first line extension terminal and a second line extension terminal, respectively.

### SUMMARY OF THE INVENTION

In the flat panel display device having a configuration as disclosed in Japanese Patent Laid-open No. 2003-197135, electron beams emitted from an electron source disposed on the side of the back substrate are accelerated to impinge on the phosphor layer of the front substrate for excitation. The excitation of the phosphor layer generates light with color according to the light emission characteristics of the phosphor layer.

However, the flat panel display device having the configuration disclosed in Japanese Patent Laid-open No. 2003-197135 has a problem in that the electrons from the electron sources partially spreads to simultaneously excite the desired phosphor layer opposed to the electron source and the phosphor layer being adjacent thereto and emitting light with a different color, generating color mixture.

The generation of the color mixture poses a problem in that the display device exhibits reduced color purity and reduced brightness, which impairs display quality.

It is an object of the present invention to provide a high-reliable and long-lived flat panel display device that prevents occurrence of color mixture, enables to ensure color purity and promote high brightness and exhibits excellent display quality.

To achieve the above object, according to an aspect of the present invention, there is provided a flat panel display device which includes a back substrate having a plurality of electron sources of a flat type, and a front substrate provided with a black matrix film having a plurality of apertures so as to enable color display, both the substrates being disposed to be opposed to each other. In this display device, the electron sources are arranged such that electron sources adjacent to each other and different in color of light from each other are different from each other in gravity center position in a direction of different-color arrangement.

A video signal drive circuit, a scanning signal drive circuit and other peripheral circuits are assembled into the flat panel display device configured as above to constitute a self-luminous flat panel display device.

Thus, a high-reliable and long-lived flat panel display device can be provided that prevents occurrence of color mixture, enables to ensure color purity and promote high brightness and exhibits excellent display quality.

### BRIEF DESCRIPTION OF THE DRAWINGS

FIGS. 1A and 1B are views for assistance in explaining an embodiment of a flat panel display device according the present invention, in which FIG. 1A is a schematic plan view as viewed from the side of the front substrate, and FIG. 1B is a schematic side view of FIG. 1A;

FIG. 2 is a schematic plan view taken along line A-A of FIG. 1B;

FIGS. 3A to 3C are views for assistance in explaining an electron source of the flat panel display device of the present invention by way of example;

FIG. 4 is a schematic plan view illustrating the relationship between the electron sources and the apertures;

FIG. 5 includes a schematic cross-sectional view of the back substrate taken along line B-B of FIG. 2 and a schematic cross-sectional view of a portion of a front substrate corresponding to the back substrate;

FIG. 6 is a schematic plan view for assistance in explaining another embodiment of the flat panel display device according to the present invention;

FIG. 7 is a schematic plan view illustrating the relationship between the electron sources and the apertures;

FIG. 8 is a schematic plan view for assistance in explaining yet another embodiment of the flat panel display device according to the present invention;

FIG. 9 is a schematic plan view corresponding to FIG. 2 with the front substrate of FIG. 8 removed;

FIGS. 10A, 10B and 10C are schematic diagrams for assistance in explaining an electron source constituting a pixel of the flat panel display device according to the present invention;

FIG. 11 is a schematic plan view illustrating the relationship between the electron sources and the apertures;

FIGS. 12A to 12C are schematic plan views for assistance in explaining other embodiments of the flat panel display device of the present invention;

FIG. 13 is a schematic plan view for assistance in explaining still another embodiment of the flat panel display device according to the present invention;

FIGS. 14A to 14D are schematic plan views for assistance in explaining other embodiments of the flat panel display device according to the present invention; and

FIG. 15 is a diagram for assistance in explaining an equivalent circuit of the flat panel display device to which the configurations of the present invention is applied.

### DETAILED DESCRIPTION OF THE PREFERRED EMBODIMENTS

Hereinafter, embodiments of the present invention will be described in detail with reference to the drawings.

### First Embodiment

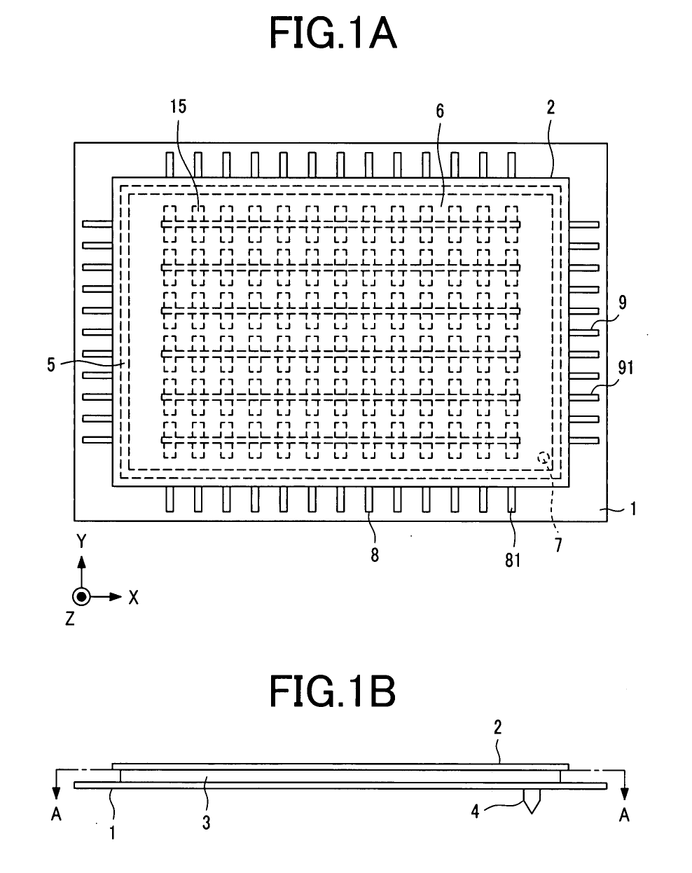

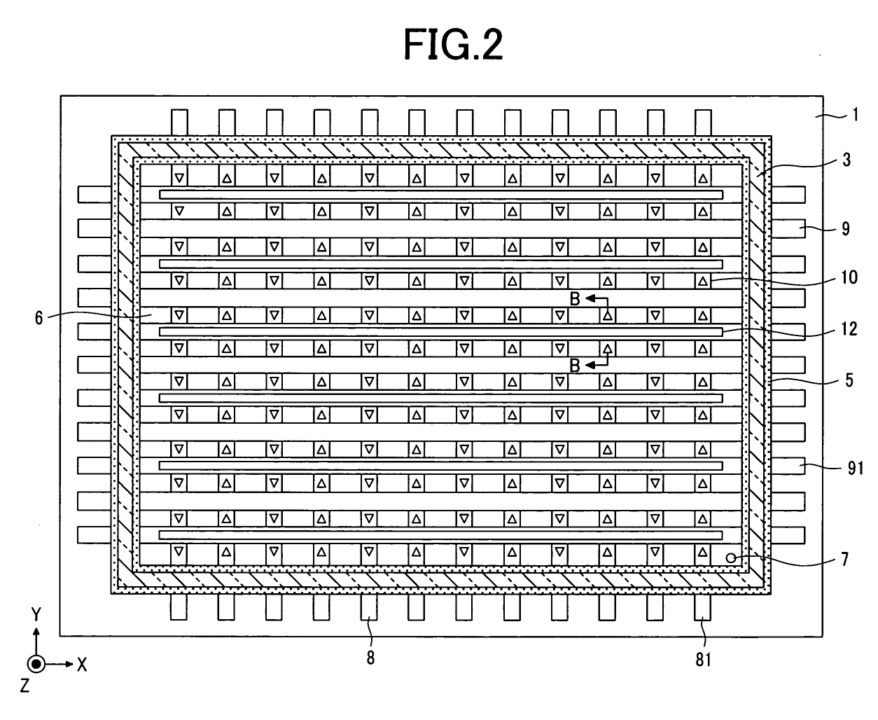

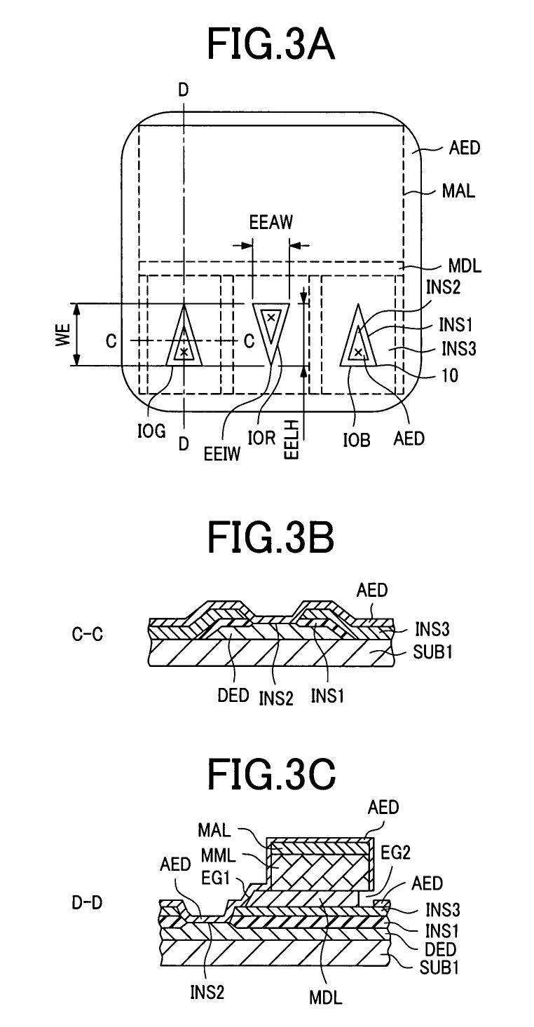

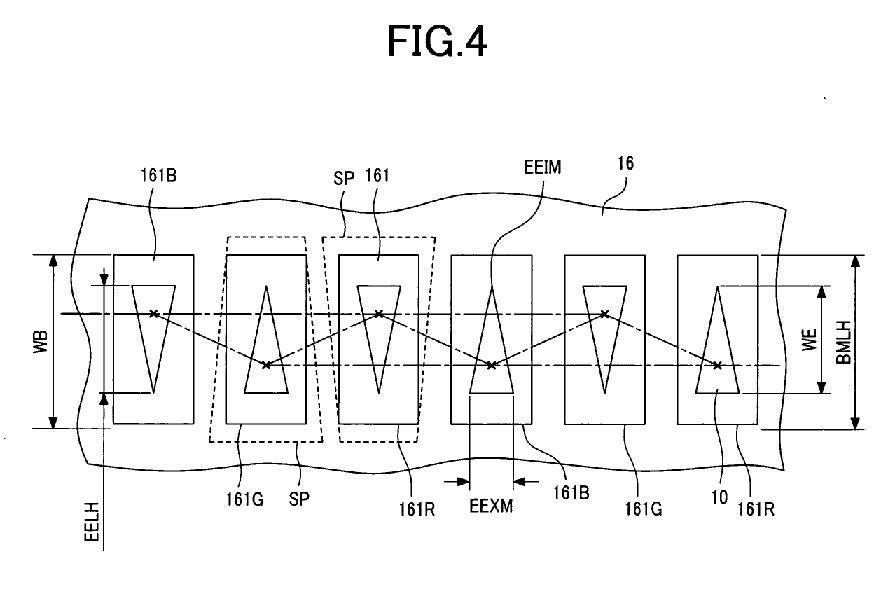

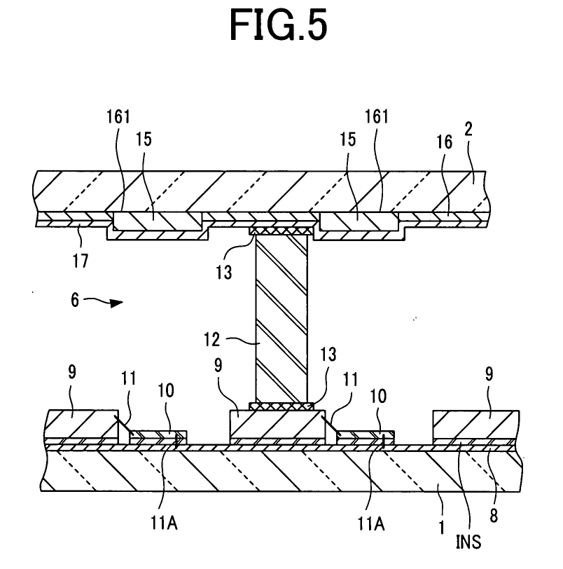

FIGS. 1A to 1B through 5 are views for assistance in explaining a flat panel display device according to an embodiment of the present invention. FIG. 1A is a schematic plan view as viewed from a front substrate side and FIG. 1B is a schematic side view of FIG. 1A. FIG. 2 is a schematic plan view taken along line A-A of FIG. 1B. FIGS. 3A, 3B and 3C are schematic views of an electron source constituting a pixel of the flat panel display device of the present invention by way of example. FIG. 3A is a plan view, FIG. 3B is a cross-sectional view taken along line C-C of FIG. 3A, and FIG. 3C is a cross-sectional view taken along line D-D of FIG. 3A. FIG. 4 is a schematic plan view illustrating the relationship between the electron sources and apertures. FIG. 5 includes a schematic cross-sectional view of a back substrate taken along line B-B of FIG. 2 and a schematic cross-sectional view of a portion of the front substrate corresponding to the back substrate.

Referring to FIGS. 1A through 5, reference numeral 1 denotes a back substrate and 2 denotes a front substrate. Each of the substrates 1, 2 is constituted of a glass plate having a thickness of a few mm, e.g., 1 to 10 mm. Both the substrates are formed in an almost-rectangle and stacked to be spaced apart from each other at a predetermined clearance.

Reference numeral 3 denotes a support frame formed like a frame. The support frame 3 is constituted of a sintered body of frit glass, or a glass plate, for example. The support frame 3 is formed of a single body or a combination of a plurality of members so as to be almost-rectangle and interposed between both the substrates 1, 2.

The support frame 3 is interposed between the substrates 1, 2 at the circumferential edge section thereof and is hermetically joined to the substrates 1, 2 at both end faces thereof. The support frame 3 is set such that its thickness is from a few mm to several tens mm and its height is approximately equal to the clearance between the substrates 1 and 2.

Reference numeral 4 denotes an evacuation pipe which is fixedly attached to the back substrate 1.

Reference numeral 5 denotes a sealing member, which is constituted of e.g. frit glass and joins together the support frame 3 and the substrates 1, 2 for hermetical sealing.

A display area 6 in a space surrounded by the support frame 3, the substrates 1, 2 and the sealing member 5 is evacuated via the evacuation pipe 4 and is maintained at a vacuum of 10⁻⁵ to 10⁻⁷ Torr. The evacuation pipe 4 is attached to the outer surface of the back substrate 1 as described above and communicates with a through-hole 7 bored to penetrate the back substrate 1. In addition, the evacuation pipe 4 is sealed after completion of evacuation.

Reference numeral 8 denotes video signal lines, which extend in one direction (Y direction) and are juxtaposed to each other in the other direction (X direction) on the inner surface of the back substrate 1. The video signal lines 8 hermetically penetrate the join area between the support frame 3 and the back substrate 1 from the display area 6 and terminate at ends of the back substrate 1. The tips of the extending video signal lines 8 serve as video signal line extension terminals 81.

Reference numeral 9 denotes scanning signal lines, which extend in the other direction (X direction) above the video signal lines 8 so as to intersect each other and are juxtaposed in the one direction (Y direction). The scanning signal lines 9 hermetically penetrate the join area between the support frame 3 and the back substrate 1 from the display area 6 and terminate at ends of the back substrate 1. The tips of the extending scanning signal lines 9 serve as scanning signal line extension terminals 91.

Reference numeral 10 denotes a flat type electron source, whose details are described later. The electron source 10 has an almost-triangular front face opposed to the front substrate 2 and is disposed near the crossing portion between the scanning signal line 9 and the video signal line 8. The electron source 10 is connected to the scanning signal line 9 and the video signal line 8 via connection lines 11 and 11A, respectively. An interlayer insulating film INS is disposed between the video signal line 8 and the electron source 10 and between the video signal line 8 and the scanning signal line 9.

The video signal line 8 uses e.g. an Al (aluminum) film and the scanning signal line 9 uses e.g. a Cr/Al/Cr film or Cr/Cu/Cr film. While the line extension terminals 81, 91 are each provided at both ends of the electrode, each of them may be provided at only one end of the electrode.

Reference numeral 12 denotes a spacer, which is made of an insulator such as a ceramic material. In general, the spacer is constituted of an insulating substrate having less unevenly distributed resistance values and shaped like a rectangular thin plate and a covering layer covering the surface of the insulating substrate and having less unevenly distributed values.

The spacer 12 has a resistance value of approximately 10⁸ to 10⁹ Ωcm and is wholly formed to have less unevenly distributed resistance values.

The spacers 12 are arranged to be almost parallel to the support frame 3, extend upright on the scanning signal lines 9 every other line and are fixedly bonded to the substrates 1, 2 with a bonding member 13.

The spacer 12 may be fixedly bonded on its one end side to the substrate. In addition, the spacer 12 is usually disposed every plurality of pixels at a position that does not interfere with the operation of a pixel.

The dimensions of the spacer 12 are set based on the size of the substrate, the height of the support frame 3, the material of the substrate, the arrangement interval of the spacers and the material of the spacer. In general, for practical values, the height is approximately equal to that of the support frame 3, the thickness is from several tens μm to a few mm, and the length is from about 20 to 1000 mm, preferably, 80 to 120 mm.

Phosphor layers 15 for red, green and blue are arranged on the inner surface of the front substrate 2 to which one end of the spacer 12 is fixed so as to be partitioned by a light-shielding BM (black matrix) film 16. A metal back (anode electrode) 17 made of a metal thin film is provided by e.g. a sputtering method so as to cover the phosphor layers and the light-shielding BM, thus forming a phosphor surface.

The metal back 17 is a light reflection film adapted to increase emission takeout efficiency by reflecting emitted-light directed toward the side opposite the side of the front substrate 2, that is, toward the side of the back substrate 1, to the side of the front substrate 2. In addition, the metal back 17 also has a function of preventing the surfaces of phosphor particles from charging.

Incidentally, while illustrated as a planar electrode, the metal back 17 may be a stripe-like electrode which is divided for each pixel row by intersecting the scanning signal lines 9.

The phosphor can use, for instance, Y₂O₃:Eu, or Y₂O₂S:Eu for red, ZnS:Cu, Al, or Y₂SiO₅:Tb for green, and Zns:Ag, Cl, or ZnS:Ag, Al for blue. The phosphor layer 15 contains phosphor particles having an average diameter of e.g. 4 to 9 μm and has a film thickness of e.g. about 10 to 20 μm.

The constitution of the phosphor surface is described in more detail with reference to FIG. 4. The black matrix film 16 is formed to cover the inner surface of the front substrate 2 so as to have a plurality of apertures 161.

The aperture 161 of the black matrix film 16 is formed in an almost-rectangle having a long side extending in the extending direction of the video signal line 8 (the vertical direction) and a short side extending in the extending direction of the scanning signal line 9 (the horizontal direction). An aperture 161B for blur phosphor, an aperture 161G for green phosphor, and an aperture 161R for red phosphor which are formed in such a rectangle have their respective gravity center positions aligned with each other in the extending direction of the scanning signal line 9. The arrangement ranges WB of the apertures are sequentially arranged in the same range as the long side length BMLH of the aperture 161 with respect to the apertures adjacent to each other in the extending direction of the scanning signal lines 9.

The green phosphor layer, the blue phosphor layer and the red phosphor layer are arranged at the respective corresponding apertures so as to close up the apertures 161 of the black matrix film 16 and extend to part of the back surface thereof.

The electron source 10 is arranged on the side of the back substrate 1 so as to face the aperture 161. The surface of the electron source 10 facing the aperture 161 is formed in an almost-triangle having an apex and a bottom in the extending direction of the video signal line 8. The electron sources 10 adjacent to each other are arranged so that the apexes of the triangles are different in direction from each other in the extending direction of the scanning signal line 9. In addition, the electron sources adjacent to each other in the extending direction of the scanning signal line 9 (the horizontal direction) are different from each other in the gravity center position of the electron source 10 indicated with an x-mark in the vertical direction. The arrangement range WE of the electron source is within the same range as the height EELH of the triangle of the electron source 10 with respect to the electron sources adjacent to each other in the extending direction of the scanning signal line 9.

The gravity center mentioned above is here defined by the gravity center position on the plane figure. Incidentally, reference symbol EEIW denotes the horizontal minimum width of the electron source and EEAW denotes the horizontal maximum width of the electron source.

The combination of the triangular shape and gravity center position of the electron source 10 and the aperture 161 forms the spot SP of electron beams incident on the phosphor surface in an almost-trapezoid. This combination can prevent the electron source from irradiating phosphor layers adjacent to each other and different from each other in color. Thus, the phosphor layer 15 emits light with a predetermined color, which is mixed with light emitted from another pixel's phosphor, constituting a color pixel with a predetermined color.

Incidentally, the surface face shape of the electron source 10 can be an almost-trapezoid similar to the aperture 161 instead of a triangle.

The electron source 10 of the present embodiment is next detailed with reference to FIGS. 3A to 3C.

The outline of the manufacturing process of the electron source of such a kind is explained based on FIGS. 3A to 3C.

In the electron source 10 of the present embodiment depicted in FIGS. 3A to 3C, a lower electrode DED (the video signal line 8 described earlier), a protection insulating layer INS1, an insulating layer INS2 are first formed on a back substrate SUB1. Next, an interlayer film INS3 and an upper bus electrode (the scanning signal line 9 described earlier) serving as a power feeder to an upper electrode AED are formed by e.g. a sputtering method or the like. While aluminum can be used for the lower electrode and the upper electrode, other metals described later can be used.

For example, a silicon oxide film, a silicon nitride film, a silicon film or the like may be used as the interlayer film INS3. If the protection insulating layer INS1 formed by anodic oxidation is formed with pinholes, the interlayer film INS3 serves to fill up the defect to secure insulation between the lower electrode DED and the upper bus electrode (a three-layered laminated film formed of a metal film lower layer MDL, a metal film upper layer MAL and Cu as a metal film intermediate film put therebetween) which will be the scanning signal electrode.

Incidentally, the upper bus electrode is not limited to the above three-layered laminated film and may be a four or more layered laminated film. For example, a metal material high in oxidation resistance such as Al, chromium (Cr), tungsten (W) or molybdenum (Mo), an alloy containing those materials, or a laminated film of those materials are used for the metal film lower layer MDL and the metal film upper layer MAL. Besides the above, a five-layered film may be used which uses a laminated film of an Al alloy and Cr, W, or Mo as the metal film lower layer MDL, a laminated film of Cr, W, or Mo and an Al alloy as the metal film upper layer MAL, and a film, made of a high-melting point metal, in contact with Cu of the metal film intermediate layer MML. If the five-layered film is used, during the heating process in the manufacturing process of an image display device, the high-melting metal serves as a barrier film to suppress the alloying of Al and Cu. Thus, the five-layered film is effective particularly in lowering resistance.

When only the Al—Nd alloy is used, the film thickness of the Al—Nd alloy is set so that the metal film upper layer MAL is made thicker than the metal film lower layer MDL. In addition, Cu of the metal film intermediate layer MML is as thick as possible in order to reduce the wiring resistance thereof. Incidentally, Cu of the metal film intermediate film MML may be formed by electroplating or the like as well as sputtering.

In the case of the five-layered film using high-melting metal, it is particularly effective that a laminated film in which Cu is inserted between pieces of Mo and which can be wet-etched with a mixed aqueous solution of phosphoric acid, acetic acid and nitric acid is used as the metal film intermediate layer MML in the same manner as Cu.

Subsequently, the metal film upper layer MAL is processed into a stripe shape intersecting the lower electrode DED by pattering of resist and an etching process. This etching process uses wet etching with the mixed aqueous solution of phosphoric acid and acetic acid for example. Since nitric acid is not added to the etchant, Cu is not etched but only the Al—Nd alloy can be selectively etched.

Also in the case of the five-layered film using Mo, when the nitric acid is not added to the etchant, Mo and Cu are not etched but only the Al—Nd alloy can be selectively etched. In this embodiment, one piece of the metal film upper layer MAL is formed in each pixel, but two pieces layers may be formed.

Subsequently, Cu of the metal film intermediate layer MML is wet etched, for example, with the mixed aqueous solution of phosphoric acid, acetic acid, and nitric acid by using the same resist film as it is, or by using the Al—Nd alloy of the metal film upper layer MAL as a mask. The etching rate of Cu in the etchant of the mixed aqueous solution of phosphoric acid, acetic acid, and nitric acid, is much higher than that of the Al—Nd alloy. Therefore, it is possible to selectively etch only Cu of the metal intermediate layer MML. Also in the case of the five-layered film using Mo, the etching rates of Mo and Cu are much higher than that of Al—Nd alloy. Therefore, it is possible to selectively etch only the three-layered laminated film of Mo and Cu. Alternatively, ammonium persulfate aqueous solution or sodium persulfate aqueous solution is also effective in etching Cu.

Subsequently, the metal film lower layer MDL is processed into a stripe shape intersecting the lower electrode DED by pattering of resist and an etching process. The etching process is performed by wet etching with the mixed aqueous solution of phosphoric acid and acetic acid. At that time, the position of a resist film printed is shifted in parallel to the stripe electrode of the metal film upper layer MAL. This causes the one side portion EG1 of the metal film lower layer MDL to protrude from the metal film upper layer MAL. The one side portion EG1 is allowed to serve as a contact portion for securing connection with the upper electrode AED in a subsequent step. On the other side portion EG2 of the metal film lower layer MDL, over-etching is performed with the metal film upper layer MAL and the metal film intermediate layer MML as a mask so as to form a set back portion as if an appentice is formed in the metal film intermediate layer MML.

The appentice of the metal film intermediate layer MML serves to separate the film of the upper electrode AED formed in a subsequent step. At that time, since the metal film upper layer MAL is made thicker than the metal film lower layer MDL, the metal film upper layer MAL can be left on Cu of the metal film intermediate layer MML even after the etching of the metal film lower layer MDL. Thus, the surface of Cu can be protected so that the oxidation resistance can be secured in spite of use of Cu, and the upper electrode AED can be separated by self-alignment, while an upper bus electrode which will be scanning signal line for power feeding can be formed. In the case where the five-layered film having Cu put between pieces of Mo is used as the metal film intermediate layer MML, Mo can suppress the oxidization of Cu even if the Al alloy of the metal film upper layer MAL is thin. Thus, it is not always necessary to make the metal film upper layer MAL thicker than the metal film lower layer MDL.

Subsequently, the interlayer film INS3 is processed to open electron emission portions. Each electron emission portion is formed in a part of a crossing portion of the space surrounded by one lower electrode DED in the pixel and two upper bus electrodes crossing the lower electrode DED. This etching can be performed by dry etching using etching gas, for example, having CF₄ or SF₆ as a chief component.

Finally, a film of the upper electrode AED is formed. A sputtering method is used to form the film. Aluminum may be used for the upper electrode AED and alternatively a laminated film of Ir, Pt and Au can be used as the upper electrode AED. In this event, the upper electrode AED is cut by the setback portion EG2 of the metal film lower layer MDL based on the appentice structure of the metal film intermediate layer MML and the metal film upper layer 18 on one side (the right side in FIG. 3C) of the two upper bus electrodes having an electron emission portion put therebetween to provide element isolation. On the other side (the left side in FIG. 3C) of the two upper bus electrodes, the film serving as the upper electrode is connected to the upper bus electrode without disconnection due to the contact portion EG1 of the metal film lower layer MDL. Thus, a structure to feed power to the electron emission portions is arranged.

The electron source 10 having such a laminated structure in this embodiment has an almost triangular surface opposed to the aperture 161 on the side of the front substrate 2.

As shown in FIG. 3A, the almost triangular electron sources 10 are arranged such that, for instance, an electron source for a green phosphor layer 10G and an electron source for a red phosphor layer 10R adjacent thereto are reversed to each other in the direction of a triangle. As a matter of course, the electron source for a red phosphor layer 10R and an electron source for a blue phosphor layer 10B adjacent thereto are reversed to each other in the direction of a triangle. In other words, the directions of the electron sources for different color emission are arranged to be reverse to each other.

On the other hand, as an example is shown in FIG. 2, the electron sources for the same color emission on the unitary video signal line 8 are arranged to face the same direction.

While the adjacent electron sources are arranged to be reverse to each other in the direction of a triangle, the arrangement range WE of the electron source is the same as the range corresponding to the height EELH of the triangle of the electron source 10 in the electron sources adjacent to each other in the extending direction of the scanning signal line 9.

### Second Embodiment

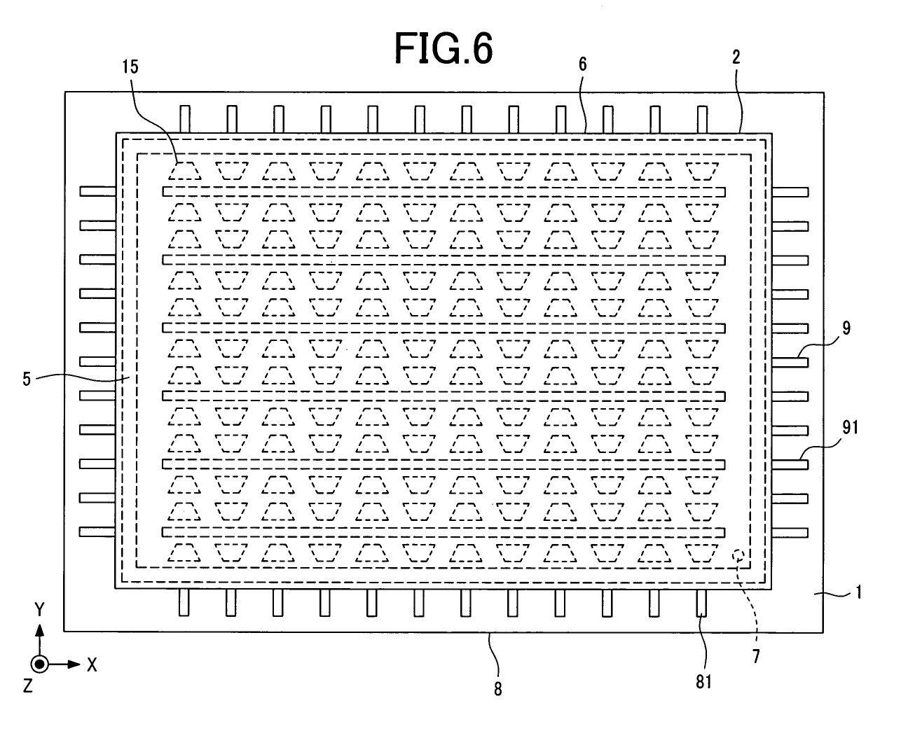

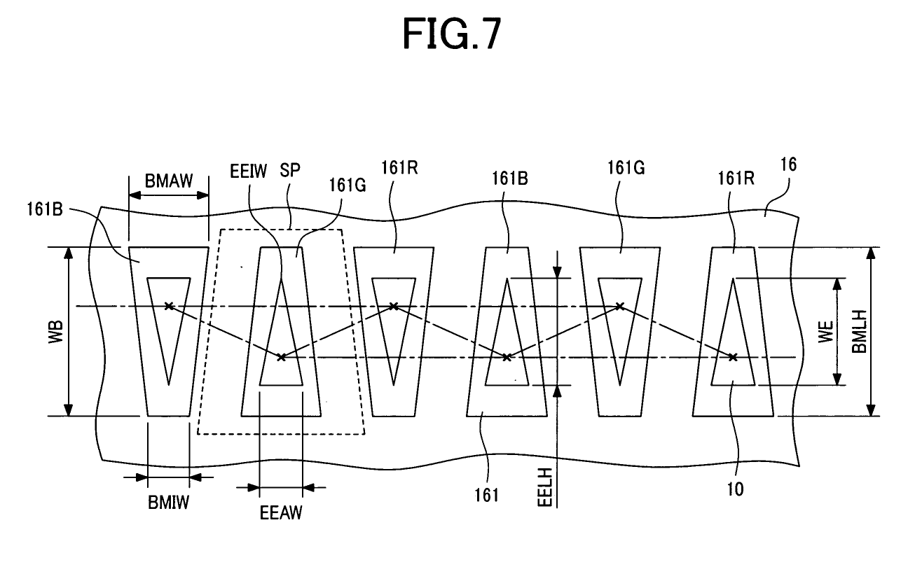

FIGS. 6 and 7 are views for assistance in explaining a flat panel display device according to another embodiment of the present invention. FIG. 6 is a schematic plan view as viewed from a front substrate side and FIG. 7 is a schematic plan view illustrating the relationship between electron sources and apertures. FIGS. 6 and 7 correspond to FIG. 1A and FIG. 4, respectively, in which the same portions in the drawings described above are denoted with the same reference symbols.

In the second embodiment illustrated in FIGS. 6 and 7, an aperture 161 is formed in an almost-trapezoid which has the maximum width BMAW at one end thereof and the minimum width BMIW at the other end. In addition, the direction of the trapezoid coincides with that of the triangle of the electron source 10. The position of the gravity center of the electron source 10 is coaxial with that of the aperture 161. The other configurations are the same as those of the first embodiment described above.

The relationship between the electron sources and the apertures can be obtained by combining the phosphor surface configuration of the second embodiment shown in FIG. 6 with the electron source array shown in FIG. 2 for the first embodiment.

The electron sources adjacent to each other are arranged to be reverse to each other in the direction of a triangle. However, the arrangement range WE of the electron source is the same as the range corresponding to the height EELH of the triangle of the electron source 10 in the electron sources adjacent to each other in the extending angle of the scanning signal line 9. In addition, also the arrangement range WB of the aperture 161 is the same as the range corresponding to the height BMLH of a trapezoid.

The configuration of the second embodiment can further reduce color mixture as compared with that of the first embodiment.

### Third Embodiment

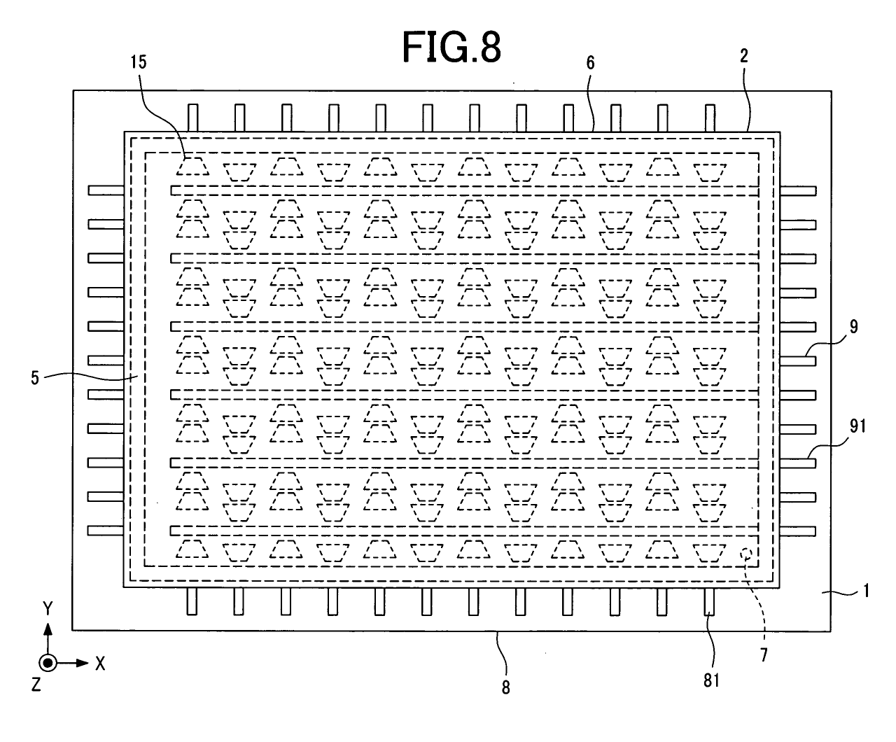

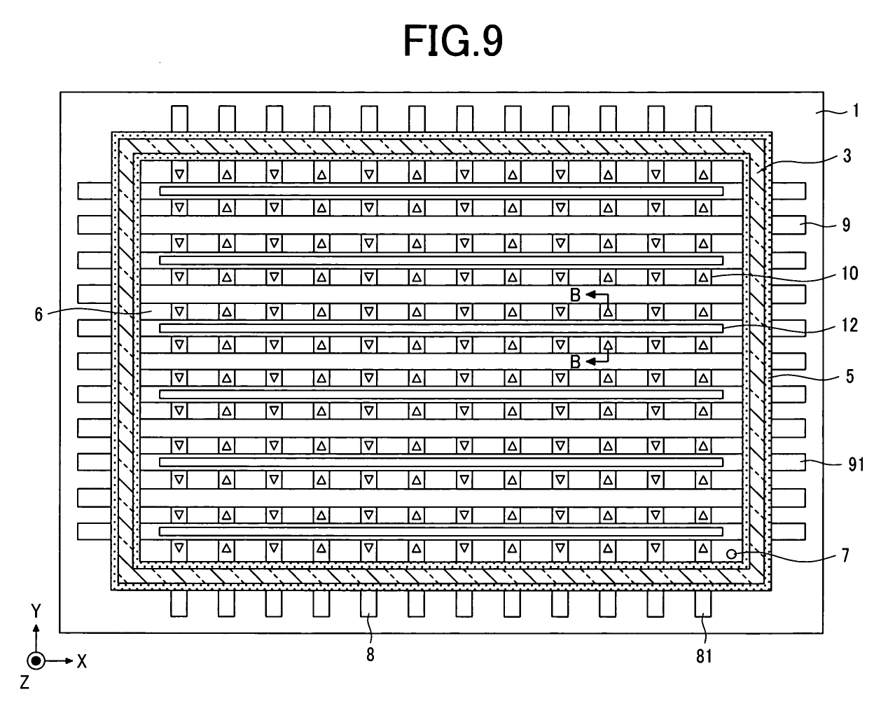

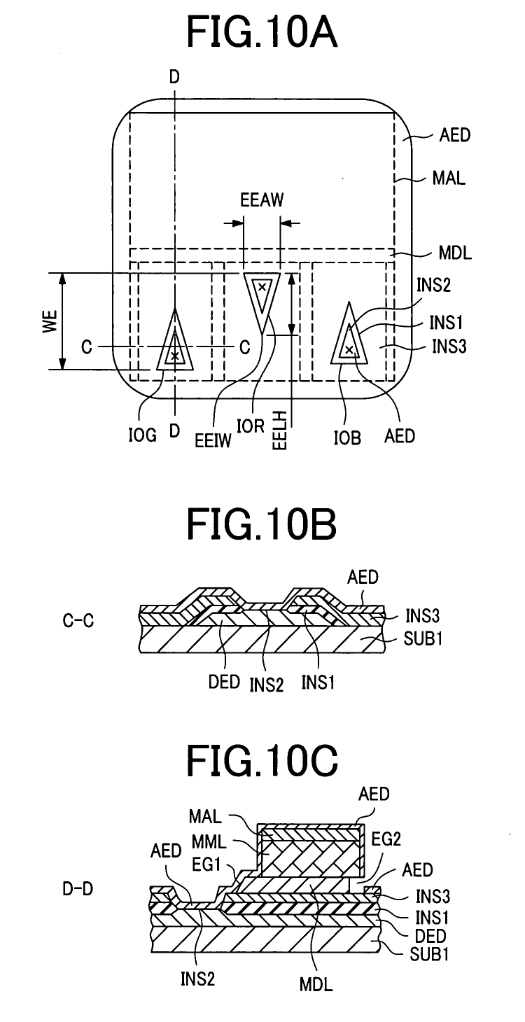

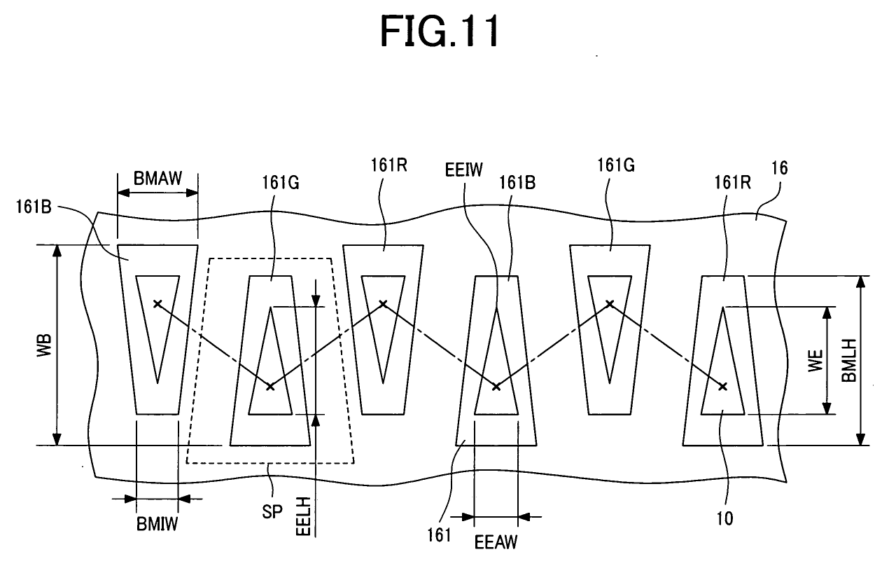

FIGS. 8 through 11 are views for assistance in explaining a flat panel display device according to yet another embodiment of the present invention. FIG. 8 is a schematic plan view as viewed from the side of the front substrate. FIG. 9 is a schematic plan view corresponding to FIG. 2 with the front substrate of FIG. 8 removed. FIGS. 10A to 10C are schematic views of an electron source constituting a pixel of the flat panel display device of the present invention by way of example. FIG. 10A is a plan view, FIG. 10B is a cross-sectional view taken along line C-C of FIG. 10A, and FIG. 10C is a cross-sectional view taken along line D-D of FIG. 10A. FIG. 11 is a schematic plan view illustrating the relationship between the electron source and an aperture. The same portions in the drawings described above are denoted with the same reference symbols.

In the third embodiment shown in FIGS. 8 through 11, the arrangement range WE of an electron source 10 is present in a range greater than the height EELH of the triangle of the electron source 10. In addition, the arrangement range WB of an aperture 161 is present in a range greater than the height BMLH of the trapezoid of the aperture 161.

On the other hand, the gravity center of the electron source and that of the aperture have the coaxial relationship and the size from the gravity center to the maximum width is set at a value smaller than that from the gravity center to the minimum width.

The configuration of the third embodiment can increase packaging density without increasing color mixture as compared with those of FIGS. 1 and 2.

### Fourth Embodiment

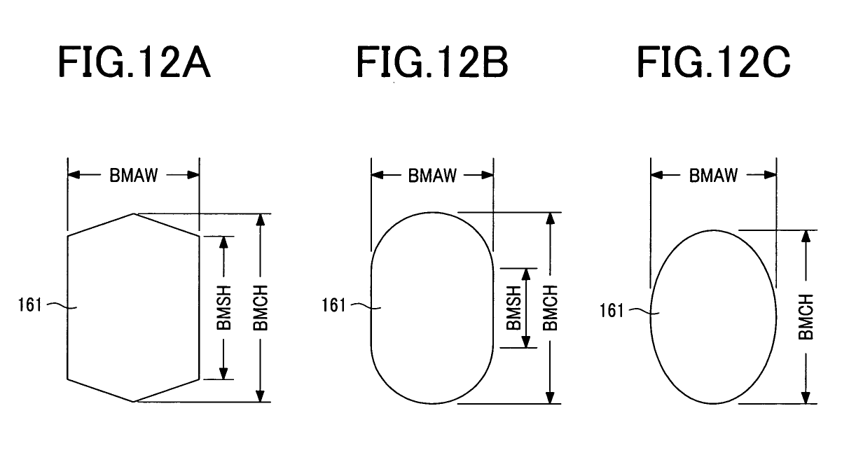

FIGS. 12A to 12C are schematic plan views for assistance in explaining a flat panel display device according to still another embodiment of the present invention. The same portions in the drawings described earlier are denoted with the same reference symbols.

FIGS. 12A to 12C illustrate the shapes of apertures 161, which have the same configuration in which the longitudinal central length BMCH is greater than the end length BMSH. Incidentally, reference symbol BMAW denotes the maximum width and has the relationship: BMCH>BMAW.

FIG. 12A illustrates an aperture formed in a substantially polygonal shape, FIG. 12B illustrates an aperture formed in a substantially oval figure and FIG. 12C illustrates an aperture formed in a shape combining circular arcs with straight lines.

A phosphor surface having the aperture 161 thus formed is configured such that the direction of the central length BMCH coincides with the extending direction of the video signal line 8.

The configuration of the fourth embodiment is characterized in that the shape of the phosphor layer 15 can be easily made to conform to that of the aperture 161.

### Fifth Embodiment

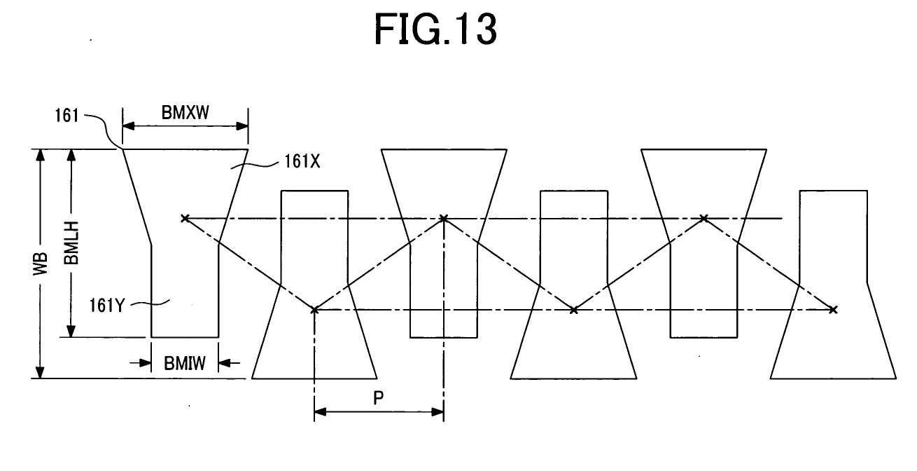

FIG. 13 is a schematic plan view for assistance in explaining a flat panel display device according to still another embodiment of the present invention. The same portions in the drawings described earlier are denoted with the same reference symbols.

FIG. 13 illustrates the shape of an aperture 161. The aperture 161 is formed by combining a trapezoidal section 161X with a rectangular section 161Y. The aperture 161 is configured such that the rectangular section 161Y has a minimum width BMIW and the trapezoidal section 161X has a maximum width BMAW. The gravity center is in the trapezoidal section 161X.

FIG. 13 shows a configuration in which apertures 161 each formed by combining a trapezoid with a rectangle are arranged such that the apertures 161 adjacent to each other are reversed to each other in the direction of the maximum width BMAW in the extending direction of the scanning signal line 9.

The configuration of the fifth embodiment can reduce the arrangement spacing P of the apertures 161 in the extending direction of the scanning signal line 9. In addition, the configuration of the fifth embodiment can ensure the desired shape of a phosphor layer and improve the tolerance of color mixture because of provision of the trapezoidal section 161X.

### Sixth Embodiment

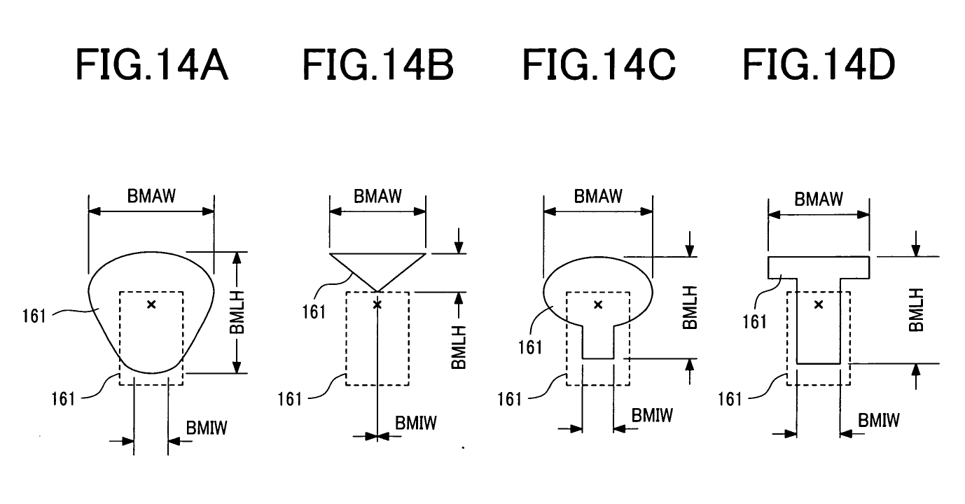

FIGS. 14A to 14D are schematic plan views for assistance in explaining a flat panel display device according to still another embodiment of the present invention. The same portions in the drawings described earlier are denoted with the same reference symbols.

FIGS. 14A to 14D illustrate other shapes of apertures 161 each having a maximum width BMAW and a minimum width BMIW.

The rectangle indicated with the dotted line shows the aperture 161 of the first embodiment described above. FIGS. 14A to 14D illustrate configurations in which an aperture 161 indicated with a solid line is arranged so as to be different in gravity center position from the rectangular aperture 161 indicated with the dotted line.

The configuration of the sixth embodiment has substantially the same feature as those of the fourth and fifth embodiments.

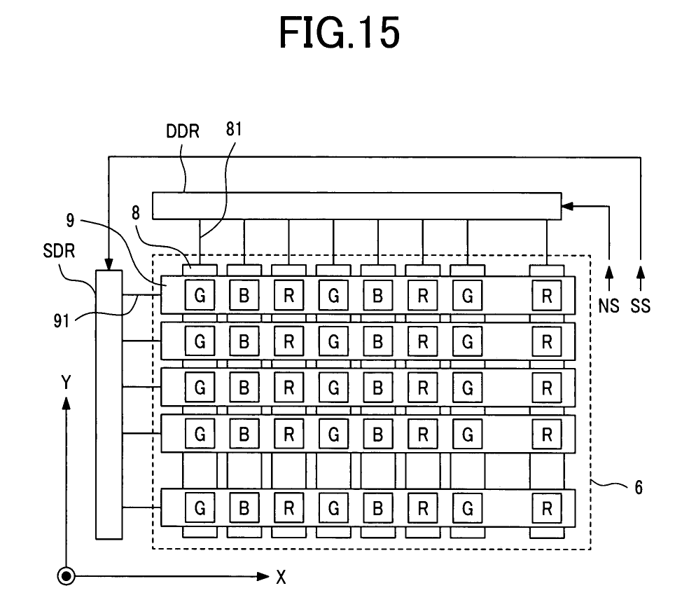

FIG. 15 is a diagram for assistance in explaining an equivalent circuit of the flat panel display device to which the configurations of the present invention is applied. The region indicated with a broken line in the figure indicates a display region 6. In this display region 6, n video signal lines 8 and m scanning signal lines 9 are arranged to cross each other, thus forming a matrix of n×m. Respective crossing portions of the matrix constitute sub-pixels and one color pixel is constituted of a group of three unit pixels (or sub-pixels) “R”, “G” and “B” in the figure. Note that the configuration of the electron source is omitted. The video signal lines (cathode lines) 8 are connected to a video signal drive circuit DDR through the video signal line extension terminals 81. The scanning signal lines (gate lines) 9 are connected to a scanning signal drive circuit SDR through the scanning signal line extension terminal 91. The video signals NS are inputted to the video signal drive circuit DDR from an external signal source, while similarly the scanning signals SS are inputted to he scanning signal drive circuit SDR.

Thus, video signals are supplied to the video signal lines 8 crossing the scanning signal lines 9 sequentially selected so as to display a two-dimensional full-color image.

Reference symbols which are used in the drawings attached to the specification are briefly described as below.

1 . . . back substrate, 2 . . . front substrate, 3 support frame, 4 . . . evacuation pipe, 5 . . . sealing member, 6 . . . display area, 7 . . . through-hole, 8 . . . video signal line, 81 . . . video signal line extension terminal, 9 . . . scanning signal line, 91 . . . scanning signal line extension terminal, 10 . . . electron source, 11, 11A . . . connection line, 12 . . . spacer, 13 . . . bonding member, 15 . . . phosphor layer, 16 . . . BM film, 161 . . . aperture, 17 . . . metal back (anode electrode), SUB1 . . . back substrate, INS . . . insulating film (interlayer insulating film), SP . . . beam spot.

What is claimed is:

1. A display device comprising:
a back substrate including:
a plurality of first lines which extends in a first direction and are juxtaposed to each other in a second direction crossing the first direction;
a plurality of second lines which extend in the second direction and are juxtaposed to each other in the first direction;
an insulating film interposed between the first lines and the second lines; and
a plurality of electron sources connected to the first lines and to the second lines;
a front substrate arranged to be opposed to the back substrate with a desired interval spaced apart from the back substrate, the front substrate including:
a black matrix film formed with a plurality of apertures in a surface thereof facing the back substrate;
a phosphor film covering the apertures; and
a metal back layer covering the phosphor film; and
a support frame interposed between the back substrate and the front substrate and arranged to surround an image display area;
wherein the electron source has an upper portion and a lower portion which are different from each other in width.

2. The display device according to claim 1, wherein electron sources adjacent to each other have respective surfaces different from each other in gravity center position, the respective surfaces facing the corresponding apertures.

3. The display device according to claim 2, wherein a portion of the aperture having a maximum width in the second direction is closer to the gravity center position than another portion having a minimum width thereof in the second direction.

4. The display device according to claim 1, wherein the aperture has portions different from each other in width along the second direction.

5. The display device according to claim 1, wherein the apertures adjacent to each other in the second direction are different from each other in gravity center position.

6. The display device according to claim 1, wherein a portion of the aperture having a maximum width along the second direction is closer to the gravity center position than another portion having a minimum width along the second direction.

7. The display device according to claim 1, wherein a gravity center position of a surface, facing the aperture, of the electron source is substantially coaxial with a gravity center position of the aperture facing the electron source.

8. The display device according to claim 1, wherein the aperture and the electron source have respective maximum widths in the same direction from respective gravity centers thereof.

9. The display device according to claim 1, wherein the electron source has an almost-triangular surface opposed to the aperture.

10. The display device according to claim 1, wherein the aperture is almost trapezoidal.

11. The display device according to claim 1, wherein the aperture has a shape combining a trapezoid with a rectangle.

12. The display device according to claim 1, wherein the electron source including a lower electrode, an upper electrode and an electron acceleration layer put between the upper electrode and the lower electrode is a thin film type electron source array in which electrons are emitted from the upper electrode by applying voltage between the lower electrode and the upper electrode.

13. The display device according to claim 1, wherein the electron source is an electron emission element provided with a conductive film having an electron emission portion.

14. The display device according to claim 1, wherein the electron source comprises at least a carbon nanotube.

15. A display device comprising:
a back substrate including:
a plurality of first lines which extend in a vertical direction and are juxtaposed to each other in a horizontal direction;
a plurality of second lines which extend in the horizontal direction and are juxtaposed to each other in the vertical direction;
an insulating film interposed between the first lines and the second lines; and
a plurality of electron sources each of which is provided near a crossing portion between the first line and the second line and are each connected to the first line and to the second line;
a front substrate including:
a black matrix film having a plurality of apertures; and
a phosphor film covering the apertures; and
a support frame interposed between the back substrate and the front substrate so as to surround a display area with an interval between the back substrate and the front substrate maintained at a predetermined clearance;
wherein the aperture of the black matrix film has a vertical length at the horizontal center portion thereof greater than that at both horizontal ends.

16. The display device according to claim 15, wherein the aperture is substantially polygonal.

17. The display device according to claim 15, wherein the aperture is substantially oval.

18. The display device according to claim 15, wherein the aperture has a shape combining a trapezoid with a rectangle.
